(19) United States
(12) Patent Application Publication
(10) Pub. No.: US 2018/0039976 A1
(43) Pub. Date: Feb. 8, 2018

(54) METHOD AND SYSTEM FOR IN-STORE WIRELESS MOBILE PAYMENT

(71) Applicant: MasterCard International Incorporated, Purchase, NY (US)

(72) Inventor: Abhinhava Srivastava, Stamford, CT (US)

(21) Appl. No.: 15/661,693

(22) Filed: Jul. 27, 2017

(30) Foreign Application Priority Data
Aug. 4, 2016 (SG) 10201606464R

(51) Int. Cl. G06Q 20/32; G06Q 20/38

(52) U.S. Cl. CPC G06Q 20/3226; G06Q 20/3821

(57) ABSTRACT

A method and system for in-store wireless mobile payment are provided. The method provides for accessing a secure wireless network used by an in-store system so as to make payment for goods or services over the secure wireless network. The method comprises initializing an application installed in a device capable of making the payment of goods or services, wherein the application is configured to generate a handshaking signal that is recognized by the in-store system to allow the device to access the secure wireless network established by the in-store system; transmitting the handshaking signal from the device to the in-store system; establishing access to the secure wireless network in response to validation of the handshaking signal by the in-store system; and initiating a payment process used to complete the payment for the goods or services.

### CROSS-REFERENCE TO RELATED APPLICATION

This application is a U.S. National Stage filing under 35 U.S.C. §119, based on and claiming benefit of and priority to SG Patent Application No. 10201606464R filed Aug. 4, 2016.

### TECHNICAL FIELD

The following discloses method and system arrangements for in-store wireless mobile payment.

### BACKGROUND

Mobile payment, a payment transaction technology performed from or via a mobile device, has emerged recently and evolved rapidly by virtue of the convenience it provides. Using mobile payment, instead of paying with cash, cheque, or credit cards, a consumer can use a payment application installed on a mobile device to pay for a wide range of services and digital or physical goods. The payment application may store details of one or more payment instruments that have been registered in the application. The one or more payment instruments may be issued by one or more financial institutions, e.g. banks, and supported by one or more intermediaries.

Due to its convenience, mobile payment has been increasingly used by the customers for online retail purchases. However, mobile payment is not readily adopted in brick and mortar stores (i.e. in-store purchases), which may assist in accelerating the processing of long queues for payment of goods or services. This may be due to many restraints. For example, one restraint may be the lack of a network connection for the mobile device, or may be because the consumer is unaware that such a network (e.g. WiFi network) is available. Further, another restraint may be that the stores do not have a system to support integration of mobile payment. Another restraint sees the mobile device finding free network access, but being unable to verify that the free network access is provided by the store. Also, for mobile payment methods that use an open loop network (such as via the internet), the connection speed may be too slow for the users to perform mobile payments.

There is thus a need to provide a method and system to facilitate and configure mobile payment for an in-store purchase. Herein disclosed is a method that operates in a secure network environment. Preferably, the secure network environment is a wireless network connected to the internet. The method and system should be configured to provide the secure wireless network in the store that does not require additional front-end input from the mobile device. Furthermore, other desirable features and characteristics will become apparent from the subsequent detailed description and the appended claims, taken in conjunction with the accompanying drawings and this background of the disclosure.

### SUMMARY

According to one aspect of the invention, there is provided a method for accessing a secure wireless network used by an in-store system so as to make payment for goods or services over the secure wireless network. The method comprises initializing an application installed in a device capable of making the payment of goods or services, wherein the application is configured to generate a handshaking signal that is recognized by the in-store system to allow the device to access the secure wireless network established by the in-store system; transmitting the handshaking signal from the device to the in-store system; establishing access to the secure wireless network in response to validation of the handshaking signal by the in-store system; and initiating a payment process used to complete the payment for the goods or services.

According to a second aspect of the invention, there is provided an in-store system for establishing a secure wireless network over which payment for goods or services is performed. The in-store system comprising: at least one processor; at least one memory including computer program code; and at least one communication interface. The at least one memory and the computer program code configured to, with the at least one processor, cause the in-store system at least to: detect a handshaking signal transmitted by an initialized application in a device used to make the payment of goods or services, wherein the handshaking signal is recognized by the in-store system to allow the device to access the secure wireless network established by the in-store system; validate the detected handshaking signal from the device; and establish access to the secure wireless network in response to validation of the handshaking signal by the in-store system, so as to allow the initiation of a payment process used to complete the payment for the goods or services.

According to a third aspect of the invention, there is provided a non-transitory computer readable medium having stored thereon executable instructions for an in-store system establishing a secure wireless network over which payment for goods or services is performed. The executable instructions cause the in-store system to perform at least the following: detect a handshaking signal transmitted by an initialized application in a device used to make the payment of goods or, wherein the handshaking signal is recognized by the in-store system to allow the device to access the secure wireless network established by the in-store system; validate the detected handshaking signal from the device; and establish access to the secure wireless network in response to validation of the handshaking signal by the in-store system, so as to allow the initiation of a payment process used to complete the payment for the goods or services.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIGS. 1A-1D show a schematic of a system in which in-store wireless mobile payment, in accordance with the present disclosure, may be performed. Each of FIGS. 1A-1D shows a stage of the in-store wireless mobile payment process.

FIG. 2 shows an exemplary computing device to realize an in-store system in accordance with the system shown in FIGS. 1A-1D.

FIG. 3 shows a flowchart depicting steps of a method that allows the system in accordance with FIGS. 1A-1D to perform in-store wireless mobile payment.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

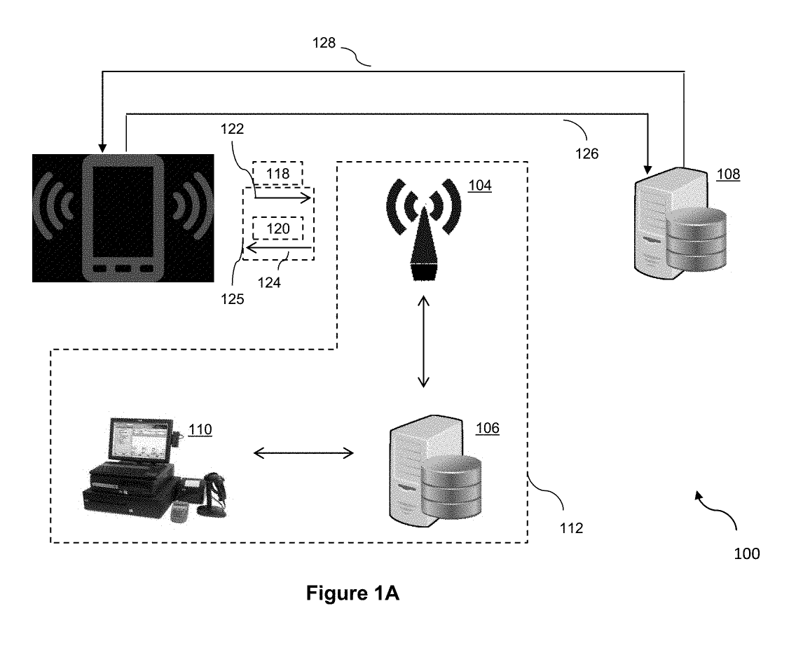

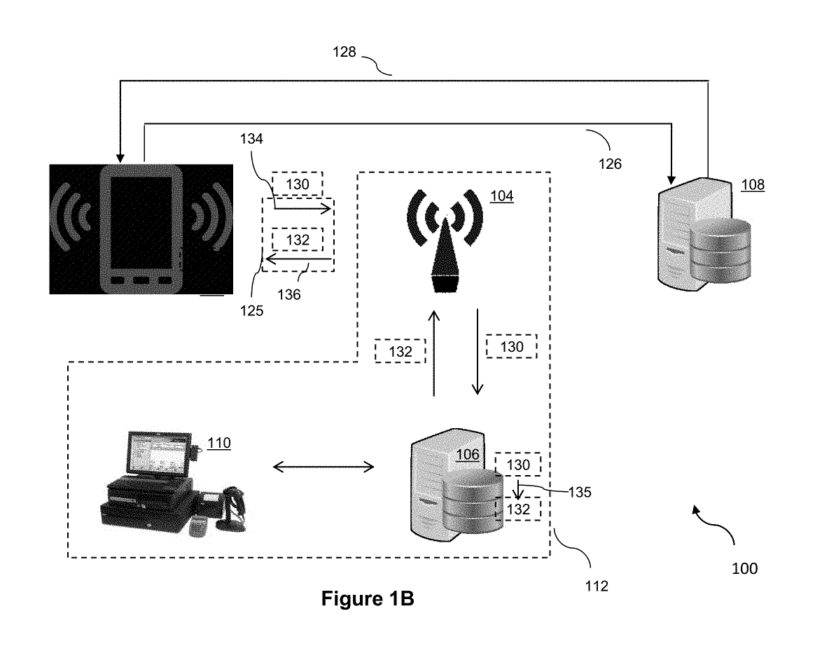

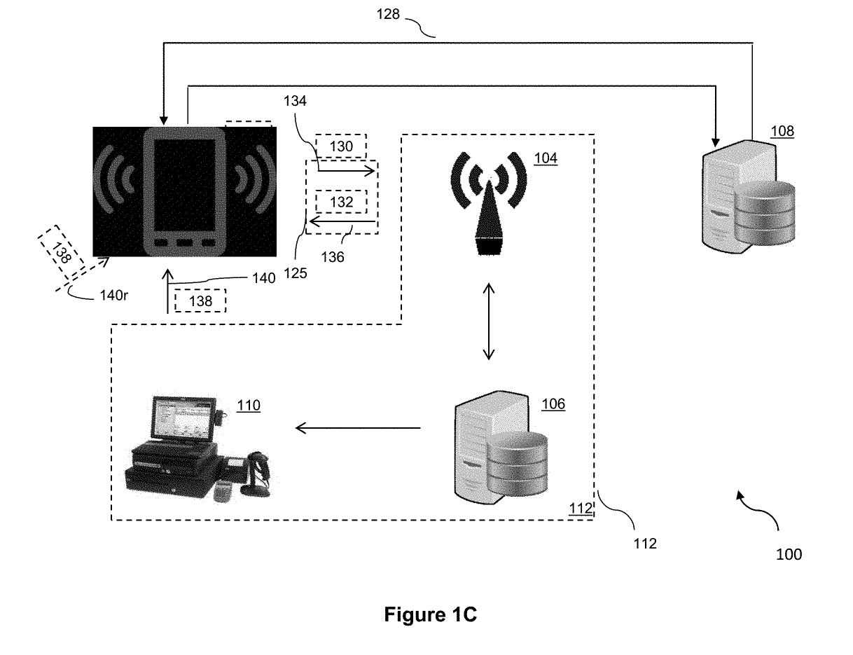

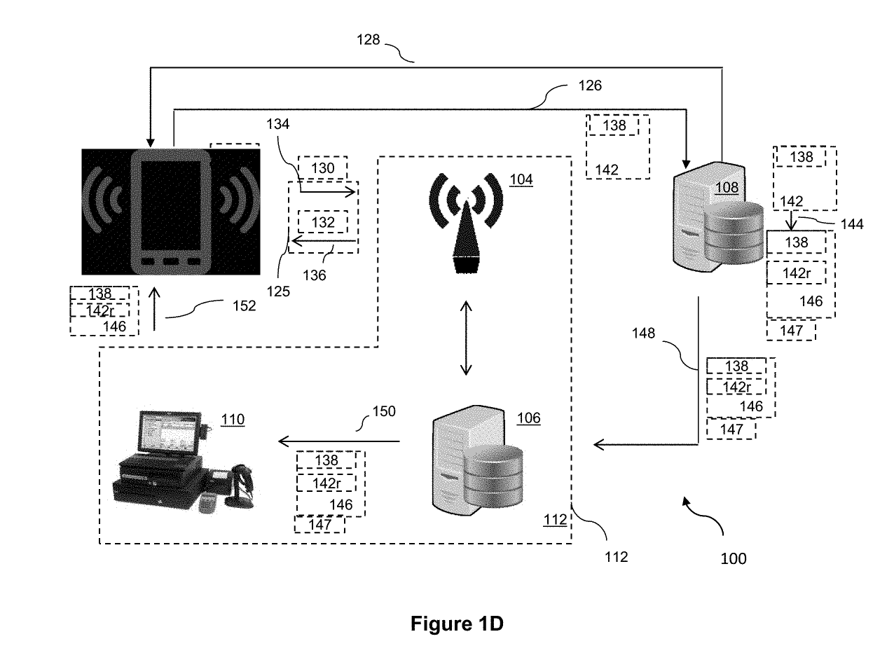

FIGS. 1A to 1D depict a schematic of a system 100 in which in-store wireless mobile payment, in accordance with the present embodiment, may be performed. Each of FIGS. 1A-1D shows a stage of the in-store wireless mobile payment process. As shown in FIG. 1A, a secure wireless network 104 is provided at the merchant's premises, i.e. in the store. In the present embodiment, the secure wireless network 104 is established and used by an in-store system 112. The in-store system 112 may also comprise a payment terminal 110 and a merchant server 106.

In the present embodiment shown in FIG. 1A, when an in-store mobile payment is sought, a consumer initializes an application 114 installed in his/her device 102. The device 102 may be a mobile phone, a tablet, a PDA, or a similar device that can be configured to network and is capable of making payment of goods and services. The store may be a market, a department store, a franchised outlet, or a restaurant. In the present embodiment, the application 114 may be designed by and belong to the merchant of the store, or designed by a third party with the consent of the merchant of the store. Upon initialization, the application 114 installed in the device 102 generates a handshaking signal (depicted as data packet 118). The handshaking signal 118 is in a format that can be recognised by the in-store system 112 and contains information that requests the in-store system 112 to allow the device 102 to access the secure wireless network 104.

The generation of the handshaking signal 118 may comprise a correct selection of the secure wireless network 104 amongst available wireless networks when one or more wireless networks are available and/or accessible in the store. For the simplicity of understanding, the one or more wireless networks available in the store are not shown in FIG. 1A. In the present embodiment, the correct selection of the secure wireless network 104 is based on recognition of the secure wireless network 104 by the installed application 114. The recognition may comprise the application 114 obtaining geographic location information from the device 102, and identifying the present store by matching the geographic location information provided by the device 102 against a plurality of geographic locations in respect of stores entered in a server with which the application 114 communicates. The recognition may also comprise the application 114 obtaining a service set identifier (SSID) from the secure wireless network 104, and identifying the present store by matching the obtained SSID of the secure wireless network 104 with a list of SSIDs provided through the application 114. The list of SSIDs may be obtained by the application 114 from the server with which the application 114 communicates. For the sake of simplicity, the server (that has a plurality of geographic locations in respect of the entered stores and/or has a list of SSIDs) with which the application 114 communicates is not depicted in FIGS. 1A-1D. The server with which the application 114 communicates may be separate from the merchant server 106. Alternatively, it may be appreciated by the skilled person in the art that the merchant server 106 may function as such a server.

As shown in FIG. 1A, the handshaking signal 118 is then transmitted 122 from the device 102 to the in-store system 112. In the present embodiment, if the handshaking signal 118 is recognised by the in-store system 112 to be valid, a validation signal 120 is then sent 124 back to the device 102 and access 125 between the device 102 and the in-store system 112 is thereby established in response to the validation of the handshaking signal 118.

The establishment of the access 125 between the device 102 and the in-store system 112 advantageously enables a secure network environment for the consumer so that the consumer can initiate a mobile payment process to complete payment for the goods or services. As shown in FIGS. 1A to 1D, the mobile payment process is performed via an electronic payment application 116 installed in the device 102. In the present embodiment, the electronic payment application 116 may be an application designed to run separately from the application 114, or an application designed to be integrated into the application 114. In the first instance, the consumer needs to initiate the payment application 116 separately. In the latter instance, the consumer can initiate the payment application 116 within the application 114. The initiation of the payment application 116 leads to establishment of communication 126, 128 between the device 102 and a payment gateway 108 with which the payment application 116 communicates.

As shown in FIG. 1B, after the access 125 is established between the device 102 and the secure wireless network 104, an authentication process is initiated between the application 114 and the in-store system 112. In the authentication process, credentials 130 of the device 102 are transmitted 134 from the application 114 to the in-store system 112. In the present embodiment, the in-store system 112 receives the credentials 130 via the secure mobile network 104, wherein the secure mobile network 104 transmits the credentials 130 to the merchant server 106. The credentials 130 of the device 102 may comprise an identifier 130 of the device 102. The credentials 130 of the device 102 may be real-time generated by the application 114 after the application 114 is initialized, or may be generated previously by the application 114 before initialization of the application 114 and retained in the application 114 for subsequent use.

Upon receipt of the credentials 130 of the device 102, the in-store system 112 generates an authentication code 132 based on the received credentials 130 of the device 102. In the present embodiment shown in FIG. 1B, the authentication code 132 is generated 135 at the merchant server 106 of the in-store system 112 based on the received credentials 130 of the device 102. It is appreciated to the skilled person in the art that the generation 135 of the authentication code 132 may be conducted by other components of the in-store system 112 not shown in FIGS. 1A to 1D.

As shown in FIG. 1B, the generated authentication code 132 is then transmitted 136 via the secure wireless network 104 (since access 125 has already been granted, as discussed above) from the in-store system 112 (specifically the merchant server 106 in the present embodiment) to the device 102.

With reference to FIG. 10, after the device 102 receives the generated authentication code 132, the mobile payment process is initiated. In the present embodiment, the mobile payment process is performed via the payment application 116 installed in the device 102.

In more detail, as shown in FIG. 10, in the mobile payment process, the device 102 receives 140, 140r data 138 of the goods or services to be purchased and activates the payment application 116 to process the received data 138 to make the payment.

As shown in FIG. 10, the data 138 of the goods or services to be purchased may be received 140 at the device 102 from the in-store system 112. In one embodiment, the data 138 of the goods or services to be purchased may be obtained by the payment terminal 110 of the in-store system 112 scanning barcodes on the goods or services to be purchased. The payment terminal 110 may then generate a code. The code may be generated as a barcode or QR code, which is captured by an image capturing apparatus (such as a camera on the device 102). Instead of physical capture of a generated barcode or QR code, the code may be wirelessly obtained, such as by transmission 140 from the payment terminal 110 to the device 102 through a Near Field Communication (NFC) connection, a wireless fidelity (WiFi) communication or a Bluetooth low energy (BLE) communication. In another embodiment, the data 138 of the goods or services to be purchased may be obtained 140r directly by the device 102, either by manually entering the information of the goods or services to be purchased into the device 102 or by the device 102 scanning barcodes on the goods or services to be purchased. Similarly, the application 114 may generate the code as a barcode or QR code, which is then captured by an image capturing apparatus (such as a scanner) of the payment terminal. Instead of physical capture of a generated barcode or QR code, the code may be wirelessly obtained, such as by transmission 140 from the device 102 to the payment terminal 110 through a NFC connection, a Wi-Fi communication or a BLE communication.

FIG. 1D details the mobile payment process in the system 100 after the payment application 116 is activated. As shown in FIG. 1D, after activation, a communication 128, 126 is established between the device 102 and the payment gateway 108 so as to enable the payment application 116 to seek approval of payment via data 142 transmitted to the payment gateway 108 via the payment application 116. The payment gateway 108 with which the payment application 116 communicates, upon receipt of the seeking approval data 142, generates 144 payment credentials 146 in response to the data 142 used to seek approval of payment. The data 142 used to seek approval of payment may comprise data 138 of the goods or services to be purchased. In the present embodiment, the payment credentials 146 may be accompanied by an indicator 147 generated 144 by the payment gateway 108 with which the payment application 116 communicates. The payment credentials 146 may comprise an identifier 142r of a payment instrument selected in the payment application 116 and the data 138 of the goods or services to be purchased. The indicator 147 provides an indicator of the completion of the payment approval.

After the indicator 147 of the payment process is generated, the payment gateway 108 of the payment application 116 transmits the indicator 147 of the payment process to the in-store system 112 along with the payment credentials 146, wherein the merchant server 106 of the in-store system 112 forwards the indicator 147 of the payment process approval to the payment terminal 110 along with the payment credentials 146. The indicator 147 can be a positive indicator that the payment of goods or services is successful or a negative indicator that the payment of goods or services is unsuccessful. In the present embodiment, the indicator 147 is a positive indicator. Upon the payment terminal 110 receiving 150 the positive indicator 146, the mobile payment is made. The payment terminal 110 then may transmit 152 the positive indicator 146 to the device 102. The transmission of the positive indicator 146 from the payment terminal 110 to the device 102 may be done via push notification in the payment application 116 or via an email sent to one of the consumer's email address entered in the application 114 and/or the payment application 116. Upon the consumer being notified with the positive indicator 146, the in-store mobile payment in accordance with the present embodiment shown in FIGS. 1A to 1D is completed.

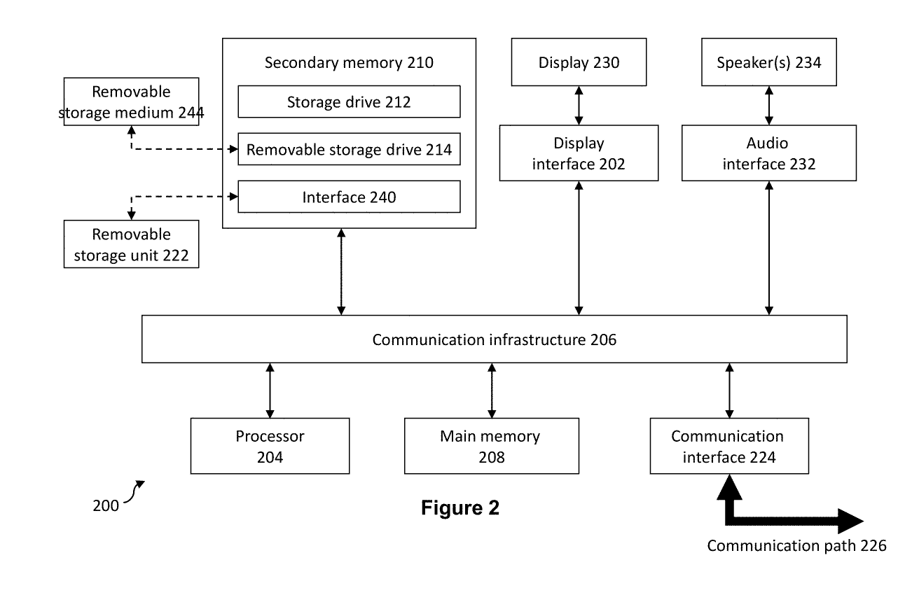

FIG. 2 depicts an exemplary computing device 200, hereinafter interchangeably referred to as a computer system 200, where one or more such computing devices 200 may be used to implement the above-described system 100 for the secure in-store mobile payment. The exemplary computing device 200 in accordance with the present embodiment can be the device 102, the merchant server 106, the payment gateway 108 of the payment application 116, and/or the payment terminal 110. The following description of the computing device 200 is provided by way of example only and is not intended to be limiting.

As shown in FIG. 2, the example computing device 200 includes a processor 204 for executing software routines. Although a single processor is shown for the sake of clarity, the computing device 200 may also include a multi-processor system. The processor 204 is connected to a communication infrastructure 206 for communication with other components of the computing device 200. The communication infrastructure 206 may include, for example, a communications bus, cross-bar, or network.

The computing device 200 further includes a main memory 208, such as a random access memory (RAM), and a secondary memory 210. The secondary memory 210 may include, for example, a storage drive 212, which may be a hard disk drive, a solid state drive or a hybrid drive and/or a removable storage drive 214, which may include a magnetic tape drive, an optical disk drive, a solid state storage drive (such as a USB flash drive, a flash memory device, a solid state drive or a memory card), or the like. The removable storage drive 214 reads from and/or writes to a removable storage medium 244 in a well-known manner. The removable storage medium 244 may include magnetic tape, optical disk, non-volatile memory storage medium, or the like, which is read by and written to by removable storage drive 214. As will be appreciated by persons skilled in the relevant art(s), the removable storage medium 244 includes a computer readable storage medium having stored therein computer executable program code instructions and/or data.

In an alternative implementation, the secondary memory 210 may additionally or alternatively include other similar means for allowing computer programs or other instructions to be loaded into the computing device 200. Such means can include, for example, a removable storage unit 222 and an interface 230. Examples of a removable storage unit 222 and interface 230 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 222 and interfaces 230 which allow software and data to be transferred from the removable storage unit 222 to the computer system 200.

The computing device 200 also includes at least one communication interface 224. The communication interface 224 allows software and data to be transferred between computing device 200 and external devices via a communication path 226. In various embodiments of the inventions, the communication interface 224 permits data to be transferred between the computing device 300 and a data communication network, such as a public data or private data communication network. The communication interface 224 may be used to exchange data between different computing devices 200 which such computing devices 200 form part an interconnected computer network. Examples of a communication interface 224 can include a modem, a network interface (such as an Ethernet card), a communication port (such as a serial, parallel, printer, GPIB, IEEE 1393, RJ35, USB), an antenna with associated circuitry and the like. The communication interface 224 may be wired or may be wireless. Software and data transferred via the communication interface 224 are in the form of signals which can be electronic, electromagnetic, optical or other signals capable of being received by communication interface 224. These signals are provided to the communication interface via the communication path 226.

As shown in FIG. 2, the computing device 200 further includes a display interface 202 which performs operations for rendering images to an associated display 230 and an audio interface 232 for performing operations for playing audio content via associated speaker(s) 234.

As used herein, the term “computer program product” may refer, in part, to removable storage medium 244, removable storage unit 222, a hard disk installed in storage drive 212, or a carrier wave carrying software over communication path 226 (wireless link or cable) to communication interface 224. Computer readable storage media refers to any non-transitory, non-volatile tangible storage medium that provides recorded instructions and/or data to the computing device 200 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 200. Examples of transitory or non-tangible computer readable transmission media that may also participate in the provision of software, application programs, instructions and/or data to the computing device 200 include radio or infra-red transmission channels as well as a network connection to another computer or networked device, and the Internet or Intranets including e-mail transmissions and information recorded on Websites and the like.

The computer programs (also called computer program code) are stored in main memory 208 and/or secondary memory 210. Computer programs can also be received via the communication interface 224. Such computer programs, when executed, enable the computing device 200 to perform one or more features of embodiments discussed herein. In various embodiments, the computer programs, when executed, enable the processor 204 to perform features of the above-described embodiments. Accordingly, such computer programs represent controllers of the computer system 200.

Software may be stored in a computer program product and loaded into the computing device 200 using the removable storage drive 214, the storage drive 212, or the interface 230. Alternatively, the computer program product may be downloaded to the computer system 200 over the communications path 226. The software, when executed by the processor 204, causes the computing device 200 to perform functions of embodiments described herein.

It is to be understood that the embodiment of FIG. 2 is presented merely by way of example to explain the operation and structure of the device 102, the merchant server 106, the payment gateway 108 of the payment application 116, and/or the payment terminal 110. In particular, the embodiment of FIG. 2 may be implemented in the merchant server 106 to at least perform: detecting the handshaking signal 118 transmitted by an initialized application 114 in a device 102 used to make the payment of goods or services, wherein the handshaking signal 118 is recognized by the in-store system 112 to allow the device 102 to access the secure wireless network 104 established by the in-store system 112; validating the detected handshaking signal 118 from the device 102; and establishing access 125 to the secure wireless network 104 in response to validation 120 of the handshaking signal 118 by the in-store system 112, so as to allow the initiation of the payment process 116 used to complete the payment for the goods or services.

Therefore, in some embodiments one or more features of the computing device 200 may be omitted. Also, in some embodiments, one or more features of the computing device 200 may be combined together. Additionally, in some embodiments, one or more features of the computing device 200 may be split into one or more component parts.

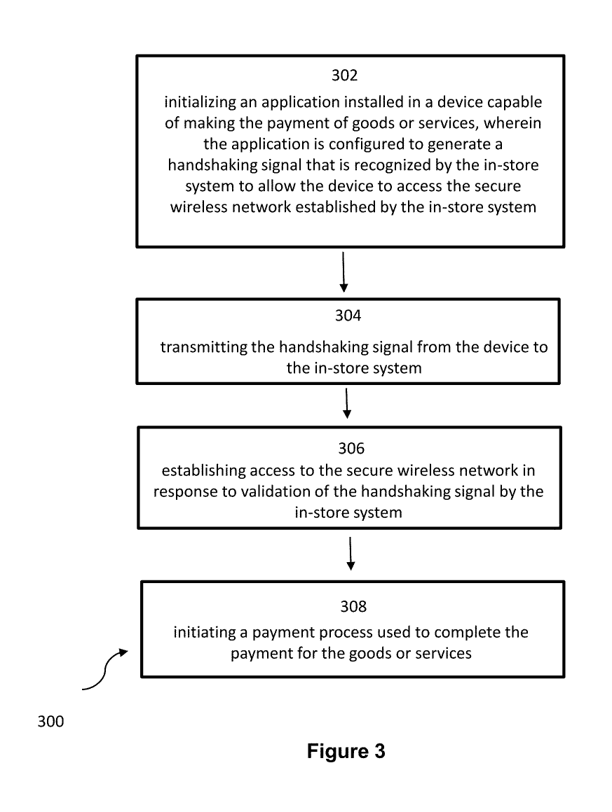

With reference to FIG. 3, the method according to the flow chart shown in FIG. 3 may be implemented as software and stored in a non-transitory fashion in the secondary memory 210 or the removable storage units 218, 222 of the computing device 200. The software is executable by the processor 204 of the computing device 200. The method allows for accessing a secure wireless network 104 used by an in-store system 112 so as to make payment for goods or services over the secure wireless network in accordance with the present embodiment. The method includes the following steps as detailed below and described with reference to FIGS. 1A to 1D.

At step 302, an application 114 installed in a device 102 capable of making the payment of goods or services is initialized. The application 114 is configured to generate a handshaking signal 118 that is recognized by the in-store system 112 to allow the device to access the secure wireless network 104 established by the in-store system 112.

At step 304, the device 102 transmits 122 the handshaking signal 118 from the device 102 to the in-store system 112.

At step 306, an access 125 is established to the secure wireless network 104 in response to validation 120 of the handshaking signal 118 by the in-store system 112.

At step 308, a payment process is initiated to complete the mobile payment for the goods or services.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for accessing a secure wireless network used by an in-store system so as to make payment for goods or services over the secure wireless network, the method comprising:
initializing an application installed in a device capable of making the payment of goods or services, wherein the application is configured to generate a handshaking signal that is recognized by the in-store system to allow the device to access the secure wireless network established by the in-store system;
transmitting the handshaking signal from the device to the in-store system;
establishing access to the secure wireless network in response to validation of the handshaking signal by the in-store system; and
initiating a payment process used to complete the payment for the goods or services.

2. The method in accordance with claim 1, wherein the generation of the handshaking signal comprises: correct selection of the secure wireless network amongst available wireless networks, the correct selection being based on recognition of the secure wireless network by the installed application.

3. The method in accordance with claim 1, further comprising after establishing access to the secure wireless network, initiating an authentication process with the in-store system, wherein the authentication process comprises
transmitting, from the installed application to the in-store system, credentials of the device;
generating, at the in-store system, an authentication code based on the received credentials of the device;
receiving, at the installed application, the generated authentication code from the in-store system.

4. The method in accordance with claim 3, wherein the credentials of the device comprises an identifier of the device.

5. The method in accordance with claim 4, wherein the credentials of the device are generated by the application after initialization of the application.

6. The method in accordance with claim 1, wherein the payment process comprises:
receiving, at the device, data of the goods or services to be purchased; and
activating an electronic payment application to process the received data and make the payment.

7. The method in accordance with claim 6, wherein the in-store system comprises a server and a payment terminal.

8. The method in accordance with claim 7, wherein the credentials of the device are transmitted from the device to the server.

9. The method in accordance with claim 7, wherein the authentication code is generated at the server.

10. The method in accordance with claim 7, wherein the device receives the data of the goods or services to be purchased from the payment terminal.

11. The method in accordance with claim 7, wherein the data of the goods or services to be purchased is manually entered into the device.

12. The method in accordance with claim 10, wherein the data of the goods or services to be purchased is received by the device reading a visual code from the payment terminal.

13. The method in accordance with claim 12 wherein the visual code is barcode or a QR (quick response) code.

14. The method in accordance with claim 6, wherein the processing of the received data in the electronic payment application to make payment comprises:
seeking approval, by the electronic payment application, of the payment from a payment gateway.

15. The method in accordance with claim 14, further comprising:
transmitting, from the payment gateway to the server of the in-store system, payment credentials in response to the completion of the payment approval.

16. The method in accordance with claim 15, wherein the payment credentials comprise an identifier of a payment instrument used by the electronic payment application to make payment for the goods or services and data of the purchased goods or services.

17. The method in accordance with claim 15, further comprising receiving, at the device, an indicator of the completion of the payment approval.

18. An in-store system for establishing a secure wireless network over which payment for goods or services is performed, the in-store system comprising:
at least one processor;
at least one memory including computer program code; and
at least one communication interface;
the at least one memory and the computer program code configured to, with the at least one processor, cause the in-store system at least to:
detect a handshaking signal transmitted by an initialized application in a device used to make the payment of goods or services, wherein the handshaking signal is recognized by the in-store system to allow the device to access the secure wireless network established by the in-store system;
validate the detected handshaking signal from the device; and
establish access to the secure wireless network in response to validation of the handshaking signal by the in-store system, so as to allow the initiation of a payment process used to complete the payment for the goods or services.

19. A non-transitory computer readable medium having stored thereon executable instructions for an in-store system establishing a secure wireless network over which payment for goods or services is performed, wherein the executable instructions cause the in-store system to perform at least the following:
detect a handshaking signal transmitted by an initialized application in a device used to make the payment of goods or, wherein the handshaking signal is recognized by the in-store system to allow the device to access the secure wireless network established by the in-store system;
validate the detected handshaking signal from the device; and
establish access to the secure wireless network in response to validation of the handshaking signal by the in-store system, so as to allow the initiation of a payment process used to complete the payment for the goods or services.
